(19) United States
(12) Patent Application Publication
(10) Pub. No.: US 2008/0127692 A1
(43) Pub. Date: Jun. 5, 2008

(54) Safety System For Operating at Least One Electrically Operated Locking Device of a Vehicle

(75) Inventors: Martin Hahner, Sindelfingen (DE); Juergen Moczygemba, Wannweil (DE); Kurt Schaible, Aidlingen (DE); Eckart Schuler, Sindelfingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/566,212

(22) PCT Filed: Jul. 21, 2004
(86) PCT No.: PCT/EP04/08140

§ 371 Date: Jan. 17, 2008

(30) Foreign Application Priority Data
Jul. 30, 2003 (DE) 103 34 711.9

(51) Int. Cl. B60R 21/01

(52) U.S. Cl. 70/277

(57) ABSTRACT

In a safety system for operating at least one electrically operated locking device of a door of a vehicle, electric opening of the locking device is inhibited dependent on sensor values which are related to the driving situation and indicate an impact. In one embodiment, inhibiting of electric opening is limited to doors that are adjacent vehicle occupants.

This application claims the priority of German patent document 103 34 711.9 filed Jul. 30, 2003 (PCT International Application No. PCT/EP2004/008140, filed Jul. 21, 2004), the disclosure of which is expressly incorporated by reference herein.

### BACKGROUND AND SUMMARY OF THE INVENTION

The invention relates to a safety system for operating at least one electrically operated locking device of a vehicle.

German patent document DE 27 51 821 A1 describes an automatic safety system for vehicles which is controlled by a driver's reflex. At a certain degree of operation of the brakes, among other things the doors are automatically locked, so that, in the event of a crash (impact), the occupants are not hurled out of the vehicle.

German patent document DE 199 06 049 A1, on the other hand, discloses a method for operating an electrically operated locking device for a glove compartment flap, in which the electric opening release of the locking device is dependent on sensor values that are related to the driving situation or are related to an event. In this case, the opening of the locking device can be suppressed for a certain period of time following a driving-critical situation. In this manner, an inadvertent opening in the event of a crash, which involves an increased risk of injury, can therefore be avoided.

One object of the invention is to provide a safety system for operating at least one electrically operated locking device of a vehicle, which ensures that the occupant is protected against unintentional opening operation from the outside.

This and other objects and advantages are achieved by the safety system according to the invention, in which electric opening of the locking device is blocked based on sensor values which are related to the driving situation, and which indicate an impact. In this case, the safety system is provided for operating at least one electrically (or fluidically) operated locking device of a door of a vehicle. This avoids the unintentional opening of vehicle body components, in particular of doors, due to acceleration forces or accident-induced actions during a hazardous situation. The body components in particular also comprise rear wall doors, flaps and lids. The occupants are prevented from unintentionally leaving the vehicle and are protected from external, endangering actions. The electric opening cannot be influenced by the driver.

In a refinement the electric opening is suppressed in response to occupation of a seat, and can be activated only for the locking devices of those body components (advantageously the door tailgate or a rear door of the vehicle) which are adjacent to the occupant. By activating the suppression of electric opening as a function of the seat being occupied, complete suppression of access to the vehicle is avoided.

Only the locking devices of those doors which are situated in the immediate, reachable region surrounding the occupants are activated by the electric opening blockage, and blocked during the hazardous situation.

Advantageously, the electric opening suppression as a function of a hazardous situation can be activated only for the locking devices of those vehicle body components which are relevant to the safety of the occupants in the hazardous situation. In this case, the electric opening blockage of the locking device can take place as a function of the speed, the acceleration and/or a rate of rotation of the vehicle. Protection of an individual occupant is ensured as a function of the hazardous situation present, with only the doors most necessary for comprehensive protection of the occupants being activated by the electric opening blockage, over the course of the hazardous situation.

Other objects, advantages and novel features of the present invention will become apparent from the following detailed description of the invention when considered in conjunction with the accompanying drawings.

### BRIEF DESCRIPTION OF THE DRAWINGS

The single FIGURE is a schematic block diagram of a safety system for operating electrically operated locking devices of a vehicle.

### DETAILED DESCRIPTION OF THE DRAWINGS

Referring to the FIGURE, the safety system 1 according to the invention, for operating electrically operated locking devices 2 to 4 of a vehicle (not shown) has a control device 5 with which the locking devices 2 to 4 can be activated. Each locking device 2 to 4 is a functional component of an outer body element of the vehicle. The body elements are, for example, doors 6, tailgate 7 or rear door 8 of the vehicle. However, other components of the vehicle which can be opened from the outside and the opened state of which could limit the safety of an occupant in a hazardous situation, are also suitable.

Electric opening of the locking device 2 to 4 is blocked as a function of sensor values which are related to the driving situation, and which indicate an impact. For this purpose, the control device 5 is activated by a sensor 9 for measuring the speed of the vehicle, a sensor 10 for measuring the acceleration of the vehicle, a sensor 11 for measuring a rate of rotation of the vehicle, sensors 12 for detecting seat occupancy in the vehicle, and a sensor 13 for detecting an accident situation of the vehicle (in particular, a crash sensor, an image-providing sensor or a radar sensor). The control device 5 can suppress opening as a function of the signal of a sensor 9 to 13, or a combination of such sensors (with it being possible for the combination to take place, for example, by means of a functional logic operation). In addition, however, other sensors for sensing sensor values that are related to the driving situation or are related to an event (such as, for example, a distance sensor) may also be provided.

In a refinement of the invention, electric opening can be blocked as a function of seat occupancy; that is, it can be limited to the locking devices of those doors 6 and tailgate 7 or rear door 8 of the vehicle which are adjacent to the occupant. For example, in the case of a four-door sedan, if the front seats are occupied, it is appropriate to activate only the two doors 6 in the front region of the interior of the vehicle by the electric opening blockage. If the rear seats are occupied, electric opening of the two rear doors 6 of the vehicle would also need to be blocked during the hazardous situation.

The electric opening blockage system according to the invention inhibits opening of only the minimum number of external body elements that is necessary to ensure the safety of the occupants in a hazardous situation. In this manner, after an accident and a possible failure of the electric closing and opening functions, access to the vehicle is nevertheless ensured (or the occupants can leave the vehicle independently), since not all access possibilities are blocked by the electric opening blockage.

In a further refinement of the invention, electric opening is suppressed as a function of a hazardous situation, only for the locking devices 2 to 4 of those body elements which are relevant to the safety of the occupants in the hazardous situation present. This means, for example, that in the case of a sharp rotation of the vehicle, due to the whirling and centrifugal forces, only the door 6 on the outer side of the curve is inhibited by the electric opening blockage. In the case of an additional occupancy of one or more rear seats, the corresponding rear door 6 is also blocked by the electric opening blockage. In the case of a typical rear end collision (which takes place directly from the rear), if appropriate none of locking devices 2 to 4 of the body elements would need to be activated by the electric opening blockage. A changing of the current state of the electric opening blockage for the various body elements over the course of the hazardous situation as a function of the movement state of the vehicle is likewise possible.

The suppression of electric opening can be maintained for a period of time that is either predetermined or variable as a function of the current values of the sensors 9 to 13.

The safety system 1 according to the invention for operating electrically operated locking devices 2 to 4 of the vehicle, ensures comprehensive protection for vehicle occupants during and after a hazardous situation. During the hazardous situation, involuntary ejection of the occupants is prevented, and it is also ensured that subsequent access to the vehicle from the outside is possible, or that the occupants can leave the vehicle by themselves. The vehicles are generally equipped with the sensors 9 to 13 as standard items, so that the safety system 1 can be realized cost-effectively with only a small outlay.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-6. (canceled)

7. A safety system for operating at least one electrically operated locking device of a door of a vehicle, said safety system comprising a control unit that is coupled to lock actuating devices for controlling electric opening of said door; wherein:
said control unit inhibits electric opening of the locking device, as a function of sensor values which are related to a driving situation and which indicate a hazardous situation; and
said inhibiting is also dependent on seat occupancy detected by means of a sensor.

8. The safety system as claimed in claim 7, wherein electric opening can be inhibited only for locking devices of doors which are adjacent to a vehicle occupant.

9. The safety system as claimed in claim 7, wherein electric opening can be inhibited as a function of a rate of rotation detected by a sensor, only for locking devices of doors on a radially outer side of the vehicle relative to a rotational axis.

10. The safety system as claimed in claim 7, wherein the door of the vehicle is one of a tailgate and a rear door.

11. The safety system as claimed in claim 7, wherein said control unit maintains an impact-induced opening blockage for a period of time.

12. The safety system as claimed in claim 7, wherein electric opening of the locking device is inhibited as a function of sensor values generated by a crash sensor.
